(19) United States
(12) Patent Application Publication
(10) Pub. No.: US 2015/0361681 A1
(43) Pub. Date: Dec. 17, 2015

(54) COMBINATION OF CONCRETE SPREADER AND CRANE TOWER

(71) Applicant: Huan DAO, Ho Chi Minh (VN)

(72) Inventor: Huan DAO, Ho Chi Minh (VN)

(21) Appl. No.: 14/764,154

(22) PCT Filed: Jul. 9, 2013
(86) PCT No.: PCT/VN2013/000008

§ 371 Date: Jul. 28, 2015

(30) Foreign Application Priority Data
Jan. 31, 2013 (VN) 1-2013-00339

(51) Int. Cl. E04G 21/04; E01C 19/47; E02D 15/02; B66C 23/16; B66C 23/26

(52) U.S. Cl. CPC E04G 21/0427; B66C 23/16; B66C 23/26; E02D 15/02; E01C 19/47

(57) ABSTRACT

The invention mentions to the complex of concrete spreader (A) and the crane tower (B), including: concrete pump (1), concrete tank (2), to be placed on the ground, sections of tremie pipes (4), (11), (20) and ball bearing (23) are fitted inside the tower sections (12) for use those sections (12) to support tremie pipe sections (11) to stand steadily in the crane tower (B), steel sections (27), (29) are fitted in the lower side of suspension arm (25) and tremie pipe sections (37a), (37b), (37c), (37d) and (37e) are inter-assembled at the lower side of steel bar (29), and steel bar (29) is used for making a guide way for these sleeve sections moving, the tremie pipe sections (77), (82), (84) are fitted with ball bearing (83) and steel hoop (85), the latch structure (88) is fitted in the front and back head of these sleeve sections, the tensile structure of moving sections (37e), (37d), (37c) and (37b) is included an electrical hoist (107), to be fitted into suspension arm (25), cable branches (108a), pulleys (110), (111), (112), (113) are fitted in suspension arm (25) for pulling of sleeve sections (37e), (37d), (37c) and (37b) to be lengthened or shortened at concrete positions, the slanting structure of sections (82), (84) is included steel section (114), oil pump (129), oil tank (133) for piston cylinder (122) to push, pull sections (82), (84) to be inclined backward and ahead at the shortest and longest concrete reach.

### TECHNICAL FIELD

Concrete spreader and crane tower are mentioned in the invention, i.e. the structure of concrete spreader and crane tower complex, in order to expand the working functions of crane tower, as well as the concrete spreader can be able to lift its height for concreting of high houses by itself and it can change by itself the length of horizontal tremie pipe, so that, the plane for construction of houses and pre-casted concrete yards can be concreted, especially, parts of concrete spreader will not be disassembled when completion of concreting for a floor and they are not also assembled when moving to a new house floor. Therefore, the working effectiveness, labor productivity and operation effect of these devices are increased.

### TECHNICAL BACKGROUND

The normally known concrete spreader is included: concrete pump to be placed on the ground, vertically-placed tremie pipe sections to be fixed on wall of house under construction, horizontally-placed tremie pipe sections to be placed on the plane, these sections are used to combine with lifting crane tower. Horizontally-placed tremie pipe sections are transported to concrete positions on the plane for implementing of functions for concrete spreader to the height of houses.

Main weakness of above-mentioned concrete spreader is that, it is not able to lift the height of vertically-placed and horizontally-placed tremie pipe sections to the working height, to the concreting positions for construction of house's height as expected. Therefore, after concreting of a floor, crane tower will be used for removal of vertically-placed and horizontally-placed tremie pipe sections out of the newly-constructed floor and transporting these parts to the new concrete positions, after that, they are assembled together at new concrete positions in order to put the concrete spreader into working. These processes of disassembly, transportation, re-assembly of parts for concrete spreader after finishing of concrete for a floor and when moving to a new concrete position not only waste time for construction of a floor, but also cost, labor consumption, so that, the concreting effectiveness is low, with high cost and time-consuming for construction of houses.

Besides, another problem is that, after concreting of a floor, concrete spreader must shut down in a long time for removal, transportation and re-assembly of its parts at hew concrete position, causing low working effectiveness, capacity of concrete pump is not used up.

While the main weakness of crane tower is that, due to the violation of limited specialization, it only has a function of lifting a heavy thing, again its working scale is limited in a range of construction plane. Therefore, working time factor of use of crane tower is small and engine capacity is not used up, insulting low effectiveness.

### SUMMARY OF THE INVENTION

In order to overcome the above weaknesses, the purpose of invention is to solve outstanding issues of concrete spreader and crane tower to be normally described above and to recommend the structure of concrete spreader and crane tower complex for expansion of working functions of crane tower and improvement of concrete spreader, in order to complete performance of these two machines in a way that is appropriate with constructing production line and increasing their working effectiveness.

Another purpose of the invention is to recommend to assemble concrete spreader on the crane tower for use of parts and structures of crane tower and concrete spreader, in order to combine a complex of concrete spreader and crane tower for construction of high houses.

One another purpose of the invention is to recommend the use of tower sections of crane tower for installation of vertical tremie pipe sections inside tower sections.

Another purpose of this invention is to propose the usage of heavy object hung on the crane tower, so that the concrete pipes can be assembled horizontally at the bottom edge of the hanging crane.

One more another purpose is to recommend that concrete spreader must be able to lengthen or shorten horizontally-placed tremie pipe sections at concrete positions as required by Technical Section in construction of houses.

Another purpose of the invention is to recommend the use of rotation structure of crane tower for turning of horizontally-placed tremie pipe at an angle of 360°, in order to concrete surrounding the complex of concrete spreader and crane tower, so that it is appropriate with constructing production line.

One more purpose of the invention is to recommend the use of height self-lifting structure of crane tower, as well as lifting the height of vertically and horizontally-placed tremie pipe sections to the desired working height.

Next purpose of the invention is to recommend the assembly of concrete spreader on the trolley of crane tower in order to use this trolley to move concrete spreader to working position in range of house's construction plane, of an architectural work and a pre-casted yard.

And one more purpose of the invention is to recommend to pre-assemble vertical tremie pipe inside tower sections in crane tower, in order when lifting of crane tower height, the height of the vertically and horizontally-placed tremie pipe section are also lifted to working position.

In order to obtain the above-mentioned purposes, it is recommended by the invention that there will have a complex of concrete spreader (A) to be fixed on crane tower (B), in which concrete tower is included: concrete pump (1), concrete tank (2) (not to be shown) to be placed on the ground, a tremie pipe section (3) to be placed horizontally near the ground surface, a curved tremie pipe section (4) to be fitted into steel sections (5a, 5b) to be horizontally placed inside the foot of crane tower, front head of tremie pipe (3) is fitted into back head of curved pipe section (4), back head of tremie pipe (3) is fitted into pipe head (8) at the head of pump (1) by pairs of flanges (6), water proof washer (9) and nuts, bolts (10);

the tremie pipe section (11) is included pipe sections of (11a), (11b) and (11c) with curved-shape to be connected with one another by pairs of flange (6), these pipe sections are fitted in vertical direction inside the tower sections of (12a), (12b) and (12c) in crane tower (B), thanks to steel sections (13) to be placed horizontally and be distanced at a fixed space at two opposite sides at tower sections of (12a), (12b) and (12c) and on these steel sections (13), steel sections (14) are fitted and placed horizontally at both sides of sections (11a), (11b) and (11c), in order to create a cylindrical steel structure frame with 04 edges supporting tremie pipe sections 11a), (11b) and (11c), these sections are fixed steadily inside crane tower (B), lower head of section (11a) is fitted into upper head of curved pipe section (4) by pair of flange (6), while upper head of pipe section (11c) is fitted in the middle of rotary structure (19) in crane tower, the curved tremie pipe (20) is fitted inside the tower section (12d) by steel sections (21), (22), which are placed horizontally at both sides of tower sections (12d) in order to tighten the pipe section (20) in this tower section (12d), while the lower head of the curved pipe section (20) is fitted into the upper head of pipe section (11c) by blank ball joint (23) in order for leading of concrete and in order for this pipe section (20) has capability of turning around ball joint (23);

crane tower (B) is separated from the house wall (C), which is under construction, a pre-specified distance to be equal to the length of steel frame (24), one head of steel frame (24) is fixed steadily into the wall (C), other head of steel frame (24) is fixed into tower sections (12) in the crane tower, the distance and quantity of these steel frame (24) are pre-determined for keeping crane tower (B) steady on the wall (C), ensuring that, the complex of concrete spreader (A) and crane tower (B) will work at safety height;

suspension arm (25) assembled under crane tower (B) is included sections of (25a), (25b), (25c), (25d) and (25e), two blank steel bars (26) are fixed at both sides of this suspension arm (25) in order to make as a guide way for vehicles with structure of lifting heavy things while moving, I profiles (27) are fixed in lower side of suspension arm (25) in horizontal way, being parallel and to be separated at a pre-specified distance, another I profile (29) including sections of (29a), (29b), (29c), (29d) and (29e) are fixed in lower side of I profile (27) for making as a guide way for tremie pipe sections with sleeve type to be placed horizontally and moved to concrete positions in the house plane, which will be described below;

at lower side of I profile sections (29a), (29b), (29c), (29d) and (29e), a tremie pipe section (37) is fixed and placed horizontally via the structure, including circular steel pipe sections of (37a), (37b), (37c), (37d) and (37e) to be embedded one another, the back head of sleeve (37a) is fixed into front head of curved pipe section (20) by pair of flange, while front head and back head of sleeve sections of (37a), (37b), (37c), (37d) are fixed with pairs of flange of (46), (54) and front head of sleeve section (37c) is fitted in back head of curved tremie pipe section (77) by pair of flange (75) and in the upper part of pairs of flange (54) (75), pairs of wheel (61) are fixed for supporting of sleeve sections of (37b), (37c), (37d) and (37c), which are moving in the lower side of steel bar (29). This makes sleeve section to lengthened or shortened at concrete positions at construction site of house, while the below head of tremie pipe (77) is fitted into the upper head of tremie pipe (82) by ball joint (83), which is able to turn by itself when concreting at longest and shortest reach and the lower head of tremie pipe (82) is fixed into the upper head of tremie pipe (84) by steel hoop (85), the pipe section (84) must be tightened steadily on tremie pipe (82);

latch bar structure (88) is used for transfer of tensile force for sleeve sections of (37d), (37c) and (37b), for moving to lengthen or transfer thrust force for these sleeve sections to be interlocked in order to shorten and transfer brake force of these sections to stop moving, is included 02 tower sections (88a) and (88b), the inside circular cylinder is empty, the front head of tower section (88a) is fitted into the side edge of front head of sleeve sections of (37a), (37b), (37c) and (37d), while the back head and front head of sections (88a), (88b) are tightened together by screw of (84), (89), latch hoop (91), latch disc (96), one-way electromagnet discs (99), (100) and brake latch (101), layer disc (103), spring (104) are fitted inside these sections of (88a), (88b) for creating of thrust force, the brake latch (101) is always fitted into holes of (105), (106) in front and back head of sleeve sections of ((37a), (37b), (37c), (37d) and (37e) for transfer of tensile force for sections of (37d), (37c), (37b) to be lengthened or transferring of brake force for sections of (37c), (37d), (37c) and (37b) to be stopped moving ad when the current applies on the electromagnet discs 99, 100 to be attracted one another, pulling latch head 101 out of the hole 106, in order for sleeve sections (37e), (37d), (37c) and (37b) to be lengthened or shortened at concrete positions;

tensile structure of tremie pipe sections (37e), (37d), (37c) and (37b) moving on the surface of I profile sections (29) is included electrical hoist (107) to be placed inside the suspension arm (25), the central part of cable wire (108) is crowned through electrical hoist (107) in some rounds for creating of 02 cable branches (108a) and (108b), and the cable branch head 108a is crowned through pulley (109) for supporting of cable branch (108a), so that it cannot touch the lower side of suspension arm (25), then it is crowned through pulleys (110), (111) at head of suspension arm (25), in order to change the movement direction of cable branch (108a) and the head of cable branch (108a) is hooked into hole (81) at claw's position (80) on the surface of flange (75), while the head of cable branch (108b) is crowned through pulley (112), (113) at tower section (12d) for changing of movement direction for cable branch (108b) and this head of cable branch is inserted into holes (45) on the surface of flanges (38), (46), (54) and this head is hooked into hole (81) at claw's position (80) on the upper part of flange (75), in order when the electrical hoist (107) rolls the cable branch (108a) into the coming drum (107), releasing the cable branch 108b out of the coming drum at the same time, so that, the cable branch (108a) can pull sleeve section (37e), (37d), (37c) and (37b) to be lengthened or when the electrical hoist (107) is changed over, rolling the cable branch (108b) into the coming drum, also releasing the cable branch (108a) out of the coming drum, so that, the cable branch (108b) pulls the sleeve section (37e), (37d), (37c) and (37b) to be shorted at concrete positions;

the structure makes tremie pipe sections (82), (84) inclined backward so that, the concreting reach is shortest and to be inclined ahead so that, the concreting reach is longest, including I profile (114) to be placed horizontally and separated from ball joint (13) a pre-fixed distance, the back head of I profile (114) is fitted into the back side of tremie pipe section (82), the front head of steel section (114) is attached vertically with 02 steel pieces (115), there is a round hole (116) in the middle of these 02 steel pieces for assembly of steel shaft, which will be described below. At two sides of pair of flange (75), two steel pieces (125) are attached at front head and tremie pipe section (37c) and at back head of tremie pipe (77), on these 02 steel pieces (125), 02 steel pieces (126) are attached horizontally and a hydraulic pressure oil pump (129) and an oil tank (133) are assembled on these 02 steel pieces (126), at the lower side of flange (75), a steel claw (118) is fixed vertically and in the middle of this steel claw (118) there is a round hole (119), the upper head of hydraulic piston cylinder (122) has a round hole (121) for fixing into the hole (119) at steel claw's (118) position by a steel shaft (123) in order to keep hydraulic piston cylinder (122) steady under this flange (75a), the lower head of hydraulic piston cylinder (122) has a round hole (117) and steel shaft (124) is used to fit into holes (116) at 02 tower pieces (115) and round hole (117) for keeping the lower head of hydraulic piston cylinder (122) being on the steel section (114), in order when the hydraulic piston cylinder (122) is operated, it will lift the steel section (114) to the height, as well as pushing tremie pipe sections (82), (84) backwards, so that, the reach of concreting is shortest, or hydraulic piston cylinder (122) pushes the steel section (114) down and tremie pipe sections (82), (84) towards to the front side, so that, the reach of concreting is longest.

### BRIEF DESCRIPTION OF THE DRAWINGS

The above purposes and other benefits of the invention will be clarified through the description of recommendations of the invention, attached with figures.

FIG. 1 is a summary picture showing the side view of concrete spreader and crane tower complex as specified in the invention.

FIG. 2 is a summary picture showing the side view and side elevation of the flange structure to be fitted into the tremie pipe placed vertically and horizontally as specified in the invention.

FIG. 3 is a summary picture showing the side view and front view of the joint structure at I profile sections of 27, 29, to be fitted into the lower side of suspension arm, which is shown in FIG. 1 as specified in the invention.

FIG. 4 is a summary picture showing the plan view to be cut out according to 4-4 line and shown in FIG. 1 with structure of sleeve-shape tremie pipe as specified in the invention.

FIGS. 5, 6, 7 and 8 are summary pictures showing the side view and front view to be shown in FIG. 4 with structure of flanges to be fitted at heads of sleeve-shape tremie pipe as specified in the invention.

FIG. 9 is a summary picture showing the side view, plan view to be shown in FIG. 1 with structure of steel hoop to be fitted at heads of tremie pipe 82, 84 as specified in the invention.

FIG. 10 is a summary picture showing the plan view to be shown in FIG. 4 with latch structure for transfer of tensile force and thrust force of sleeve-shape tremie pipe being lengthened or shortened and transferring of brake forces for pipe sections when stop moving.

FIG. 11 is a summary picture showing the side view to be shown in FIG. 1 with tensile structure of sleeve-shape tremie pipe sections to be lengthened or shortened at concrete positions as specified in the invention.

FIG. 12 is a summary picture showing the side view of vertical tremie pipe to be pre-fixed inside the tower sections, as specified in the invention.

FIG. 13 is a summary picture showing the side view and front view with structure for tension and pushing of tremie pipe sections of 82, 84 inclined backward and forward, as shown in FIG. 1 according to the invention.

FIG. 14 is a summary picture showing the side view and front view with the structure for lifting of heavy things in the complex of concrete spreader and crane tower as specified in the invention.

FIG. 15 is a summary picture showing the side view of cable tackle diagram at heavy thing lifting structure for the complex of concrete spreader and crane tower as specified in the invention.

FIG. 16 is a summary diagram showing the side view of structure for pulling of small vehicle at the structure for lifting of moving things in the complex of concrete spreader and crane tower, as shown in FIG. 1, according to the invention.

FIG. 17 is a summary picture showing the side view of the complex of concrete spreader and crane tower with assembly of concrete pump on parts of moving vehicle in the crane tower as specified in the invention.

FIG. 18 is a summary picture showing the side view of the complex of concrete spreader and crane tower according to the invention in the condition when concreting from the shortest reach to the longest reach and from the longest reach to the shortest reach, according to the invention.

FIG. 19 is a summary picture showing the side view of the complex of concrete spreader and crane tower with function of crane tower, according to the invention.

### DETAILED DESCRIPTION OF THE INVENTION

Types of crane tower and concrete spreader mentioned in this document are the ones which have been known already. So that, the detailed description of their structure, formation principle, principle of working, control system and working functions can be discarded. Only their detailed parts relating to the formation into a complex is briefly described, in order for coordinating with movements of these machines' structures to complete the technical properties of the complex of concrete spreader and crane tower as mentioned here.

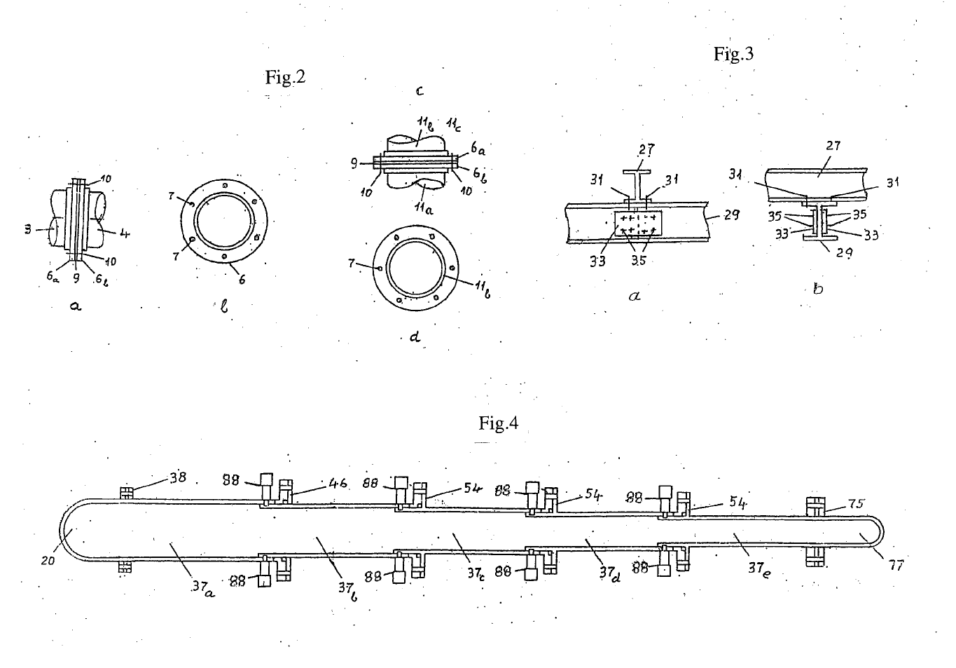

Figures from 1-16 show the complex of concrete spreader A and crane tower B as specified in the invention, in which, concrete spreader A is placed on the ground, including concrete pump 1, concrete tank 2 (not to be shown), tremie pipe section 3 to be placed horizontally near the ground, the cross section crossing the pipe section is a circle, with pre-specified diameter and length of pipe section, circular tremie pipe section 4 is fitted into steel sections of 5a, 5b to be placed horizontally in two opposite edges at the foot of crane tower by a steady weld, this circular pipe section 4 also has circular cross section, with pre-specified diameter and length of pipe section. Pairs of flanges 6 (FIGS. 2a, 2b) are fitted in the front head and back head of pipe section 3, including 02 parts: flange part 6a and flange part 6b, the dimensions of inside diameter and outside diameter of this pair of flange 6 are pre-specified, as well as the flange part 6a, 6b are punched with round holes 7 for fitting of nuts and bolts, the flange part 6a is tightened into the front head and back head of pipe section 3 by electrical weld, while the flange part 6b is tightened into pipe section 8 at head of pump 1 and fitted into the back head of circular pipe section 4 by electrical weld, as well, water proof washer 9 is fitted in the middle of pair of flanges 6a, 6b and nuts and bolts 10 are fitted into holes 7 as above mentioned for tightening of flange part 6a, 6b and water proof washer 9—so that, pipe section 3, 4 and 8 are sealed, concrete cannot goes out.

Tremie pipe section 11 is included sections 11a, 11b and 11c to be fitted vertically inside and in the centre of tower sections 12a, 12b and 12c in crane tower, thanks to steel sections 13 to be placed horizontally in 02 opposite sides, which are separated a pre-fixed distance on tower sections 12a, 12b and 12c and on these steel sections 13, steel sections 14 are placed horizontally for fitting sections 11a, 11b and 11c by electrical weld for forming of cylindrical steel structure frame with 04 edges supporting of tremie pipe sections 11a, 11b and 11c to be steady inside tower sections 12a, 12b and 12c in crane tower, tremie pipe sections 11a, 11b and 11c in tower sections 12a, 12b and 12c has circular cross section, with pre-specified diameter and length of pipe section, pairs of flanges 6 (FIGS. 2c, 2d) are fitted in the front head and back head of tremie pipe sections 11a, 11b and 11c and the front head of circular pipe section 4 by electrical weld for sealing of upper and lower head of sections 11a, 11b and 11c as well as the upper head of circular pipe section 4, so that, concrete cannot goes out and self-lifting structure is fitted in tower section 12 of crane tower B, including hydraulic oil pressure pump 15, hydraulic piston cylinders 16, guiding frame 17, cantilever arm 18 for supporting of crane section when being assembled and disassembled for forming a self-removable structure of tower section 12b and for lifting height in crane tower by itself as well as height of tremie pipe section to be placed horizontally and vertically at working positions. At upper head of section 12, a rotary structure 19 is fitted for turning of suspension arm in crane tower on horizontal plane, which are known parts in crane tower, while inside the section 12, the curved tremie pipe section 20 are fitted into steel sections 21, 22 to be placed opposite at 02 edges and inside section 12d by steady electrical weld, the cross section of curved pipe section 20 is a circle, with dimensions of diameter and height of section 20 is pre-specified, the lower head of section 20 is fitted into the upper head of pipe section 11c by ball joint 23 with empty inside having function of self-turning for circular section 20 according to crane tower on horizontal plane and the position of crane tower B is separated from the house wall C, which is under construction, a distance being equal to length of steel frame 24 for tightening of crane tower B into the house wall C, ensuring that, the crane tower can be steady for safe working at height.

Suspension arm 25 is fitted in front of crane tower B, including sections 25a, 25b, 25c, 25d and 25e, cross section of these sections are isosceles triangles with structure including multiple steel sections to be put together by electrical weld and steel shafts for bearing force, dimensions of length, width and height of these section 25 are already known, 02 steel bars, including sections 26a, 26b, 26c, 26d and 26e are fitted in 02 edges of this suspension arm for making of guideway for small vehicles with heavy lifting structure in crane tower (already known) and I steel profile 27 are placed parallel in the lower edge of sections 25a, 25b, 25c, 25d and 25e, which are separated evenly from a pre-fixed distance by steady electrical weld, dimensions of length, width and height of I steel profile 27 are pre-specified, round holes 28 (not to be shown) are arranged in the lower edge and in the center of I profile 27 for fitting of nuts and bolts, which are described below and also in the central lower edge of I profile 27, a steel I profile 29, including sections 29a, 29b, 29c, 29d and 29e, are fitted with dimensions of length, width and height of I steel profile 29 to be pre-specified, round holes 30 (not to be shown) are arranged in the upper edge at both heads and in the center of sections 29a, 29b, 29c, 29d and 29e, as well as nuts and bolts 31 are used for fitting into holes 28, 30 (in steel I profile 27 and I 29), sections 29a, 29b, 29c, 29d and 29e are tightened steadily in the lower edge of 127, round holes 32 (not to be shown) and 02 steel rectangular pieces 33 with pre-specified length and width are arranged in the front and back heads of I profile 29a, 29b, 29c, 29d and 29e and these 02 steel pieces 33 are punched with round hole 34 (not to be shown), nuts and bolts 35 are used for fitting into holes 32, 34 for tightening steadily of 02 steel pieces 33 into 02 sides of front head and back head of I profile 29a, 29b, 29c, 29d and 29e (FIG. 3a, 3b) (and the steel section I29a only has round hole 32 in front head, no hole 32 in the back head and as for section I29c, round hole 32 is only available in back head, no hole in front head) and at lower edge of front head and back head of section I29, round holes 36 (not to be shown) are arranged for fitting of nuts and bolts, which will be described below. While in the lower edge of sections 29a, 29b, 29c, 29d and 29e, tremie pipe section 37 is placed horizontally, including sections 27a, 27b, 27c, 297 and 27e to be put together, dimensions of inside diameter, outside diameter and length of this sleeve are pre-specified in a the most optimal way for concreting at the longest and shortest reach and when disassembly and assembly, as well as transporting, sections of suspension arm 25a, 25b, 25c, 25d and 25e , sections of I29 including 25a, 25b, 25c, 25d and 25e, sections of tremie pipe 37a, 37b, 37c, 37d and 37e, it is easy and convenient when handling of the complex of concrete spreader and crane tower. And one more thing to be paid attention is that, before removing of these section out of I profile 29, sections of 37e, 37d, 37c, 37b must be compacted into a section of 37a with the shortest length.

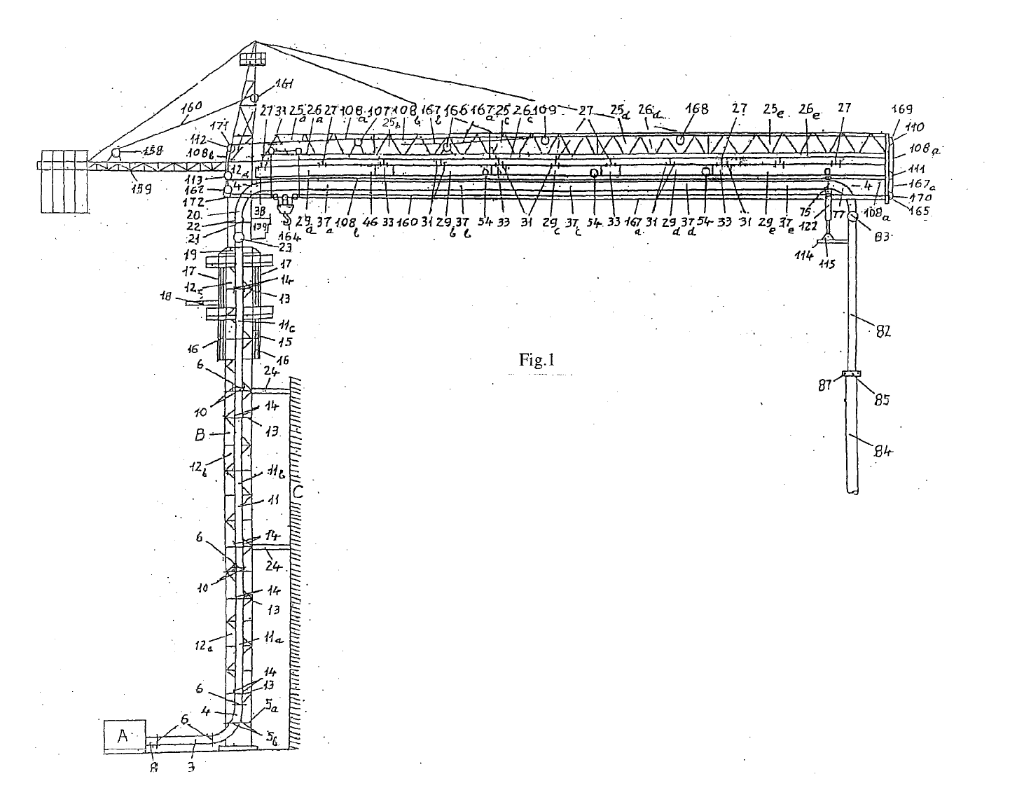

FIG. 4 shows the section 4-4 in FIG. 1 showing the structure f sleeve-shape tremie pipe sections 37a, 37b, 37c. 37d and 37e, with maximum length and to be fitted one another by pairs of flange as described below.

FIG. 5 shows the structure of pair of flange 38 in FIG. 4, including 02 parts, the part of flange 38a and 38b, dimension of inside and outside diameter of this pair of flange are pre-determined and on part of pair of flange 38a, 38b, round holes 39 are arranged for fitting of nuts and bolts, which will be described below, the part of flange 38a are tightened into the front head of curved pipe section 20 by steady electrical weld, the part of flange 38b are also tightened into the back head of sleeve 37a by steady electrical weld, water proof washer is fitted in the middle of flange 38 and nuts & bolts 41 are used to fit into holes 39 for tightening of flange 38a and water proof washer 10 is fitted in flange 38a for sealing of front head of curved pipe section 20 and the back head of sleeve 37, so that, concrete cannot seep out, in the upper part of flange 38, steel piece 42 is placed horizontally by electrical weld, dimensions of length, width of this steel piece 42 are pre-specified and on this steel piece 42, round holes 43 (not to be shown) are arranged, nuts and bolts 44 are used for fitting in holes 43 in steel piece 42, fitting in holes 36 at lower side and in the back head of I profile 26a for steadily supporting of section 37a. And also on the flange 38a, rectangular hole 45 is arranged for inserting of cable to lengthen sleeves 37e, 37d, 37c, 37b or pulling these sleeve to be embedded one another for shortening at concrete positions in houses under construction, which will be described below.

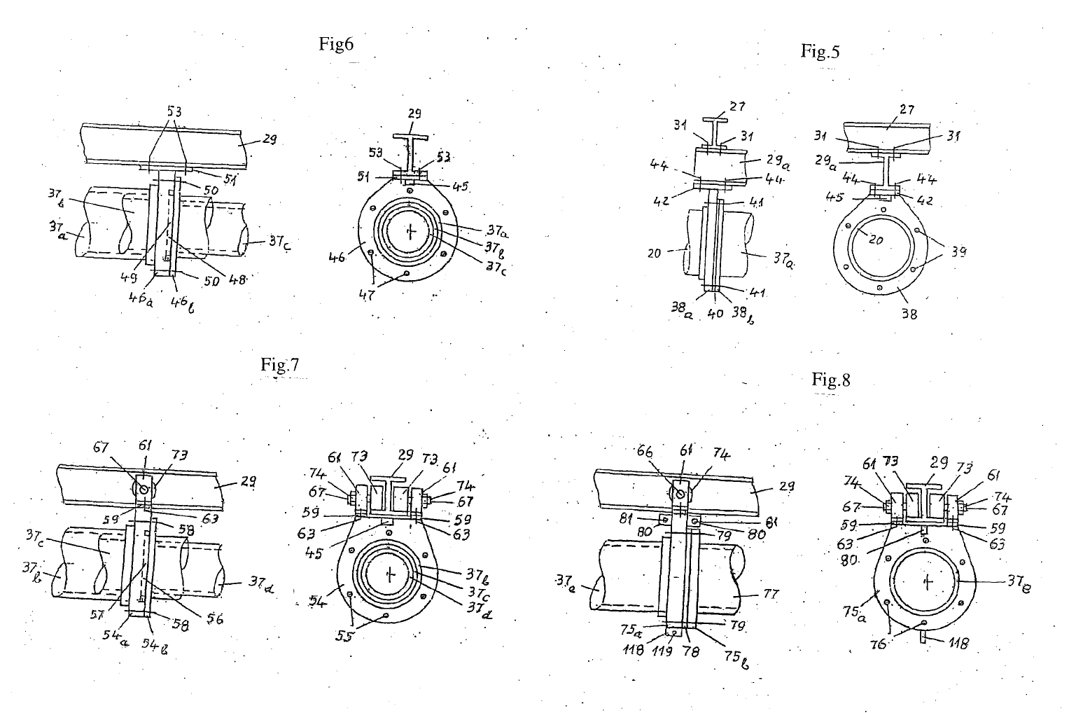

FIG. 6 shows the structure of pair of flange 46 in FIG. 4, including 02 parts, the part of flange 46a and 46b, dimension of inside and outside diameter of this pair of flange are pre-determined and on part of pair of flange 46a, 46b, round holes 47 are arranged for fitting of nuts and bolts, which will be described below, the part of flange 46a is tightened into the front head of sleeve 37a by a steady electrical weld, inside the part of flange 46a, there is a space 48 for fitting of water proof washer 49 and nuts & bolts 50 are used for fitting in holes 47 for tightening of part of flange 46b and water proof washer 49 into part of flange 46a, so that, the water proof washer 49 can fit with the back head of sleeve 37b and the front head of sleeve 37a for sealing of front and back head of sleeve 37b, 37a, thus, concrete cannot seep out, on the upper part of flange 46a, a steel piece 51 is placed horizontally by electrical weld and on this steel piece 51, round holes 52 (not to be shown) are arranged, nuts and bolts 53 are used for steady fitting into holes 52 and holes 36 (at lower side of the front head of I profile 29a), to support the front head of sleeve 37a at lower side of this I profile 29a and also on the upper part of flange 46a, rectangular hole 45 are arranged, which will be described below.

FIG. 7 shows the structure of pairs of flange 54 in FIG. 4, also including 02 parts, part of flange 54a, part of flange 54b, dimension of inside and outside diameter of this pair of flange 54 are pre-determined and on part of pair of flange 54a, 54b, round holes 55 are arranged, part of flange 54a is fitted into the front head of sleeve 37b, 37c, 37d by a steady electrical weld, inside the part of flange 54a, there is a space 56 for fitting of water proof washer 57 and nuts & bolts 58 are used for fitting into holes 55 for tightening of part of flange 54a, water proof washer 57 into part of flange 54a, so that, the water proof washer 57 can fit with the front head of sleeve 37b, 37c and 37d and the back head of sleeve 37c, 37d, 37e for sealing of front and back head of these sleeve sections, thus, concrete cannot seep out, on the upper part of flange 54a, 02 steel piece 59 are placed horizontally by electrical weld and on 02 these steel piece 59, round holes 60 (not to be shown) are arranged for fitting of nuts & bolts, which will be described below, on 02 these steel pieces 59, 02 bearings 61 are installed vertically, dimensions of height, width and distance of 02 these bearings are base on those of I profile 29, while in the lower head of 02 bearings 61, round holes 62 (not to be shown) are arranged and nuts & bolts 63 are used to fit into holes 60, 62 as described above for tightening of 02 bearings 61 on the upper part of flange 54a, while in the middle of 02 bearings 61, round holes 64 are arranged and in these holes 64, lock groove 65 is placed horizontally (not to be shown), dimensions of hole diameter, length of hole 64 and width, height, length of lock groove 65 and lock latch 66 (not to be shown) in this hole 64 are pre-determined and round bar shaft 67 for fitting into hole 64 at 02 bearings 61 will be described below, dimensions of shaft diameter and length of shaft 67 will be pre-specified and at the back head of round bar shaft 67, threads 68 and 69 (not to be shown) are carried out, as well as the central space of steel shaft 67 is tightened into hole 64 at bearing 61 by lock latch 66 and lock groove 65, the front head of steel shaft 67 is fitted into round hole 70 at bearing 71 and this bearing 71 is fitted into hole 72 (not to be shown) in wheel 73 at the lower edge of I profile 29 and bolt 74 is used to fit in thread 69, so that, the bolt 74 can fit in thread 68 and the stability of steel shaft 67 can be increased on bearing 61 for supporting of sleeve sections 37b, 37c, 37d and 37e when these section move on I profile 29 and on part of flange 54a, rectangular hole 45 is arranged as described above.

FIG. 8 shows the structure of pair of flange 75 in FIG. 4, including 02 parts, part of flange 75a, part of flange 75b, dimensions of inside and outside diameter of this pair of flange 75 are pre-determined and on part of pair of flange 75a, 75b, round holes 76 are arranged, part of flange 75a is tightened in the front head of sleeve 37e by a steady electrical weld, part of flange 75b is fitted into the back head of curved tremie pipe 77 by electrical weld, as well, in the lower part of flange 75a, 75b, water proof washer 78 is fitted, nuts and bolts 79 are used for fitting in holes 76 for tightening of flange 76b, water proof washer 78 fitting in the flange 75a for sealing of front head of sleeve 75a and the back head of curved pipe section 77, so that, concrete cannot seep out, while on flange 75a, claws 80 are placed vertically along the sleeve sections 37a, 37b, 37c, 37d and 37e and on these claws 80, there are round holes 81 for hooking in cable wire and lengthening sleeve sections 37e, 37d, 37c, 37b or pulling these sleeve sections to be embedded one another for shortening, as clearly shown in FIG. 11, items of 59, 61, 63, 67, 73, 74 are described (in FIG. 7).

While the lower head of curved pipe section 77 is fitted in the upper head of tremie pipe 82 by empty ball joint 83 and the lower head of pipe 82 is fitted into the upper head of tremie pipe 84 by steel-cored rubber, with function for easily and conveniently putting this expansion pipe 84 into concrete positions, dimensions of diameter, length of tremie pipes 82, 84 are pre-determines, while inside diameter of expansion pipe 84 is equal to outside diameter of pipe section 82 and the upper head of expansion pipe 84 is fitted in the lower head of pipe 82 by steel hoop 85, as shown in FIG. 1.

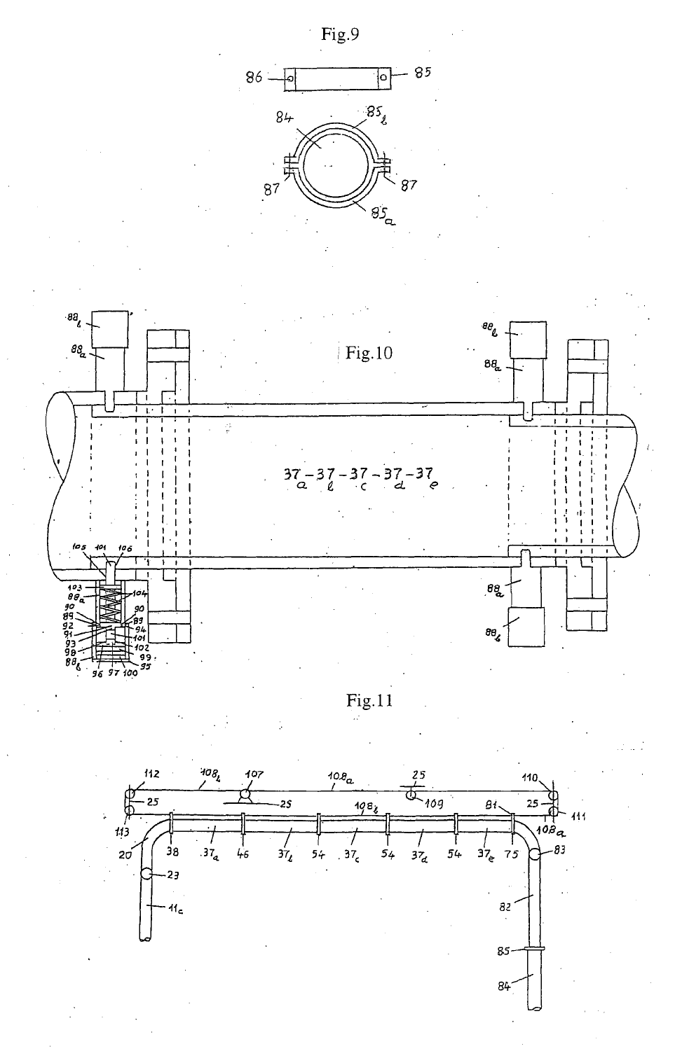

FIG. 9 shows the steel hoop 85, as specified in the solution of invention's implementation, including 02 parts, the parts of steel hoop 85a and 85b, in order when disassembly and assembly of steel hoops 85a and 85b into pipe sections 82, 84, they are carried out easily during operation process, dimension of inside diameter of steel hoop 85 is equal to outside diameter of expansion pipe 84, while height, thickness of this steel hoop 85 are pre-determined, both ends of steel hoops 85a, 85b are bent in zigzag shape and round holes 86 (not to be shown) and nuts & bolts 87 are used to fit into holes 86 for tightening of steel hoops 85a, 85b into the upper head of pipe 84 and into the lower head of pipe 82, so that, the pipe section 84 is fixed stably at pipe section 82.

FIG. 10 shows the structure of brake latch 88 for transfer of tensile force on sleeve sections 37b, 37c, 37d and 37e to be lengthened and pulling these sections to be embedded one another for shortening and transferring of brake force for those sleeves to stop moving. According to the solution of invention, at the front head of both sides of sleeve section 37a and in front, back head at both sides of sleeve sections 37b, 37c, 37d and the back head of both sides of sleeve sections 37c, the structure of brake latch 88 is fitted into, including, 02 circular cylindrical steel pipe sections 88a, 88b, dimensions of inside, outside diameter and length of 02 these pipe sections 88a, 88b are pre-determined, pipe section 88a has outside diameter being more than the inside one of section 88b, the front head of section 88a is tightened next to the front head of outside sleeve sections 37a, 37b, 37c, 37d by a steady electrical weld, while the head back of section 88a, thread 89 is carried out at outside diameter and thread 90 is carried out at inside diameter (not to be shown) and the inside back head of section 88a is fitted with latch hoop 91 with circular shape, diameter and thickness of latch hoop are pre-determined and the thread 92 (not to be shown) is carried out at outside diameter of latch hoop 91 for tightening into the thread 90 at inside diameter of section 88a, for fitting of latch hoop 91 inside the section 88a and in the middle of larch hoop 91, there is a round hole 93 (not to be shown) for fitting of brake latch, which will be described below, while in the front head of section 88b, thread 94 (not to be shown) is carried out at inside diameter of the section for fitting into thread 89 at outside diameter of section 88a, for steadily tightening the front head of section 88b into the back head of section 88a and in the back head of section 88b, a circular steel piece 95 is fitted, diameter of this steel piece 95 is equal to the outside diameter of section 88b, while thickness of this steel piece 95 is pre-determined and inside the section 88b, a circular lock disc 96 is fitted, the thickness of this lock disc 96 is pre-determined, while the outside diameter of lock disc 96 is less than the inside diameter of section 88b, in the central point of the lower side of lock disc 96, round hole 97 (not to be shown) is arranged and this round hole 97 is carried out with thread 98 (not to be shown), while on the surface of lock disc 96, an one-way electromagnet lock disc 99 is attached and in the lower side of steel piece 95, an one-way electromagnet lock disc 100 is attached, as well, and inside sections 88a, 88b, a section of brake latch 101 is fitted, the diameter and length of this brake latch 101 is pre-specified, at back head of brake latch 101, thread 102 (not to be shown) is carried out, to be separated from the front head of latch 101 a pre-specified distance, with circular step disc thread 103, diameter of step disc 103 is less than the inside diameter of section 88a, while thickness of disc step 103 is pre-determined and also being located inside the section 88a, but outside the latch 101, spring 104 is fitted, diameter of spring 104 is less than the inside diameter of section 88a, while length of spring 104 is more than the distance from the upper side of step disc 103 to the lower side of latch hoop 91 and the back head of latch 101 is fitted into round hole 93 at latch hoop 91 and fitted into hole 97 at latch disc 96 by thread 102 to be tightened into thread 98 at latch disc 96 for fixing the latch 101 inside sections 88a, 88b, while the front head of latch 101 is fitted into hole 105 at front head of sleeve sections 37a, 37b, 37c, 37d and fitted into hole 106 at back head of sleeve section 37b, 37c, 37d and 37e. Due to the fact that, the length of spring 104 is more than the dimension of distance from step disc 103 and latch hoop 91, the thrust force has been created for the front head of brake latch 101 being in the mode fitting into hole 106 at the back head of sleeve section 37b, 37c, 37d and 37e for transferring of tensile force of sleeve section 37d, 37c, 37b to be lengthened and when DC current applies on the one-way electromagnet discs 99, 100, it is more prominent than the tensile force of spring 104 for pulling the front head of latch 101 out of the hole 106, so that, sleeve sections 37e, 37d, 37c, 37b are pulled in order that, they will be embedded into sleeve 37a at shortest position.

FIG. 11 shows the summary picture of the structure for lengthening of sleeve section 37b, 37c, 37d and 37e or pulling them to be embedded one another as specified in the invention. The structure for pulling of these sleeve sections 37b, 37c, 37d and 37e, according to this solution, is included an electrical hoist 107, to be placed inside the suspension arm 25, as shown in FIG. 1, the middle section of cable wire 108 is rolled in electrical hoist drum 107 in some rounds, one end of cable branch 108a is crown through pulleys 109 for supporting of cable 108a, in order for it not to touch the lower side of suspension arm 25 and crowing through pulleys 110, 111 at end of suspension arm 25 for changing the movement direction of cable 108a and the head of cable branch 108a is hooked into hole 81 at claw's position 80 on the surface of flange 75a, while the other end of cable branch 108b is crown through pulleys 112, 113 at tower distance 12a for changing the movement direction of cable 108b to be inserted into holes 45 on the surface of pairs of flange 38, 45, 54 and head of cable 108b is hooked into hole 81 at claw's position 80 at flange 75, in order when electrical hoist 107 rolls cable wire 108a into the coming drum 107 and releasing the cable branch 107b out of the coming drum 107 for pulling of sleeve sections 37e, 37d, 37c, 37b to be lengthened up to the full length of this sleeve, so that, the sleeve section 37 has the maximum length, on the contrary, when the electrical hoist 107 is changed over, rolling the cable branch 108b around the coming drum 107 and releasing the cable branch 108a out of the coming drum 107, so that, the cable 108b will pull sleeve sections 37e, 37d, 37c, 37b to be embedded one another and embedded completely inside the sleeve 37a, in order for the tremie pipe 37 having the minimum length.

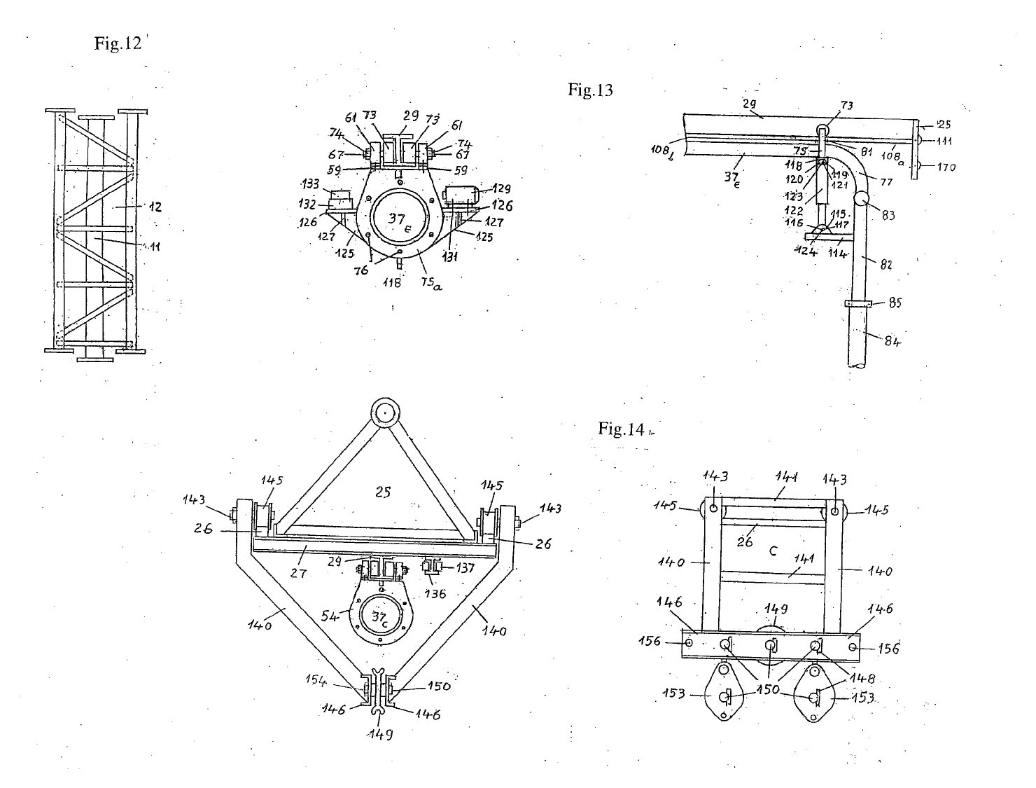

FIG. 12 shows the tremie pipe 11 to be pre-assembled inside the tower section 12, so that, when the height of crane tower is lifted, height of concrete spreader is also lifted up to the working position.

In order for the tremie pipe sections 82, 84 to be able to concrete at shorter and longer reach, compared to the optimal solution of the invention, as described above, it is recommended by solutions of invention implementation, the structure for pulling of tremie pipes 82, 84 to be inclined backward at a specific angle for obtaining a shortest reach of concreting or pulling tremie pipe sections 82, 84 to be inclined ahead at a specified angle for obtaining a longest reach of concreting.

FIG. 13 shows structure turning tremie pipe section 82, 84 backward and ahead according to the implementation plan of the invention, the structure for keeping and turning of tremie pipe section 82, 84 as specified by this solution includes the following parts:

As briefly description in FIG. 1, the empty ball joint 33 with self-turning function is fitted in lower of curved tremie pipe section 77 and in the lower head of tremie pipe 82 when the force is applied on, at position being separated from ball joint 33 a pre-fixed distance, I profile 114 is fitted and placed horizontally, making an arm bearing tensile and thrust force of tremie pipe sections 82, 84 turning ahead and backward, dimension of length, height of I profile 114 is pre-determined, the back head of I profile 114 is tightened into back side of tremie pipe 82 by a steady electrical weld, while in the front head of I profile 114, 02 steel pieces of 115 are fitted in parallel, to be distanced a pre-fixed distance, according to vertical direction by electrical weld and there is a round hole 116 in the middle of these steel pieces 115, dimension of length, height, diameter of hole in these 02 steel pieces are based on those of steel piece 117 in lower head of hydraulic piston cylinder, which will be described below. In lower side of flange 75a (FIG. 8), a steel claw 118 is fixed vertically, there is a round hole 119 in the middle of this claw, dimension of length, height, diameter of hole 119 in the claw 118 is based on dimension of width of flange 75a and height, length of 02 steel pieces 120 and hole diameter 121 in the upper head of hydraulic cylinder 122 and 02 these steel pieces 120 and round hole 121 are fitted into claw 118 and hole 119 by steel shaft 123 for keeping hydraulic cylinder 122 steady under the flange 75a, while the hole 117 in lower head of hydraulic cylinder 122 is fitted into hole 166 at 02 steel pieces 115 by round steel shaft 124 for keeping the lower head of piton cylinder 122 on the I profile 114 and in the central part at 02 sides of flange 75a, 02 steel pieces 125 is fitted vertically, standing opposite one another through pipe section 37e (FIG. 13). Two steel pieces 126 are fitted on that of 125 by steady electrical weld, dimensions of length, width and height of two steel pieces 125, 126 are pre-specified and steel pieces 127 are fixed vertically in lower side of steel pieces 126 for supporting and increasing the stability of steel pieces 125, 126 on flange 75a and round holes 128 (not to be shown) are arranged on steel piece 126 in the right of flange 75a and on this steel piece 126, hydraulic pressure oil pump 129 is installed on steel piece 126, at lower part of hydraulic pressure oil pump, round holes 130 are punched (not to be shown) and nut and bolt 131 are fixed into holes 128, 130 for tightening steadily of hydraulic oil pump 129 on steel piece 125, while on steel piece 126 in the left of flange 75a, 04 steel pieces 132 are fixed vertically next to steel piece 126, dimensions of length, width, height at 04 steel pieces 132 are based on those of oil tank 133 for supporting steadily and safely of oil tank 133 on steel piece 126 and pipe sections 134 are used to lead hydraulic oil from oil pump 129, which is fixed into the cylinder head 122 for supply hydraulic oil for cylinder 122 and return oil pipe 135 is used for recovery of oil from cylinder 122 back to oil tank 133 (not to be shown) and in the lower side of I profile 27, to be placed horizontally and in the lower side of suspension arm 25, a I profile 136 (FIG. 14) are fixed into, dimensions of length, height of I profile 136 are pre-determined and wheels 137 are fitted in lower side of I profile 136 for supporting of wire line 138 to be moved under this I profile 136 and terminals of the wire line 138 are plugged into hydraulic oil pump 129, which is known in ports and control system of hydraulic pump 129 and the work piston cylinder are arranged in cabin room 139 in crane tower B.

FIG. 14 shows the heavy-thing lifting structure C in the complex of concrete spreader A and crane tower B, including 04 steel sections 140, which are fitted in parallel in pairs to be separated from a pre-fixed distance at both sides of suspension arm 25, dimensions of sides and length of 04 these steel sections 140 are pre-specified, the cross section of 04 these steel sections 140 is empty rectangle, the upper part of 04 steel section 140 is curved vertically at both sides of suspension arm 25, the lower part of 04 steel section 140 is inclined at lower side of suspension arm 25, in upper head, in the middle part of steel section 140 and at both sides of suspension arm 140, 04 steel sections 141 are placed vertically, in parallel and being separated from pre-fixed distance and 02 heads of tower section 141 are tightened at both inner sides of steel sections 140 by fixed electrical weld, dimensions of length, width of sides of 04 these steel sections 141 are pre-specified, the cross section of steel section 141 is empty rectangle, the upper head of 04 steel sections 140 has round hole 142 (not to be shown) for assembly of steel shaft 143 and the front head of steel shaft 143 are fitted into bearing 144 (not to be shown) in wheel 145, which is placed on two steel bard 26 in order for small vehicle under structure of heavy thing lifting, moving at both sides of suspension arm 25 are known parts, while the lower head of 04 steel sections 140 is fitted into heads of U profile 146, which is placed horizontally, being separated from a pre-determined distance by steady electrical weld, dimensions of length, width and height of U profile 146 are pre-specified, round holes 147 are arranged at sides of U sections 146 in parallel and in pairs (not to be shown) for fitting of steel shaft, which will be described below, dimensions and diameter of hole 147 and distance of holes 147 are pre-fixed. At sides of hole 147 in U section 146m, a steel piece 148 is fixed by electrical weld for avoiding of steel shaft's rotation, which is fitted into hole 147, dimensions of length, width and thickness of steel piece 148 are pre-specified and at pair of hole 147, in the middle of U profile 146, pulley 149 and steel shaft 150 are fitted into hole 147, which is fitted into hole 151 in bearing 152 (not to be shown) in pulley 149, while in 02 pairs of hole 147 in steel sections 140, pulley 153 is fitted with capability of self-rotation according to cable branches in tackle of heavy thing lifting cable, which will be described below, the upper head of pulley 153 is fitted into steel shaft 150 and bolts 154 are used for tightening of steel shaft 150 into braking steel 148 in U profiled 146, which is used for supporting of pulleys 149, 153 in this U profile 146 (steel shafts 150 and steel piece 148, pulley 149, 153 are normally known parts and items in the crane) and there are holes 155 (not to be shown) at both sides of U-sections 146 for fitting of steel shaft 156 and there are bolts 157 for hooking of cable terminals having heavy thing lifting structure, moving on 02 steel bars 26 at both sides of suspension arm 25 in the crane tower, which will be described below.

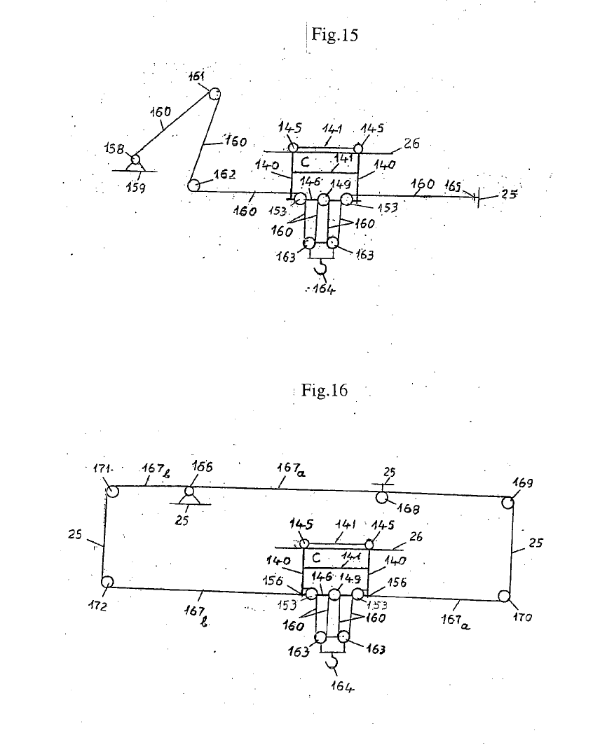

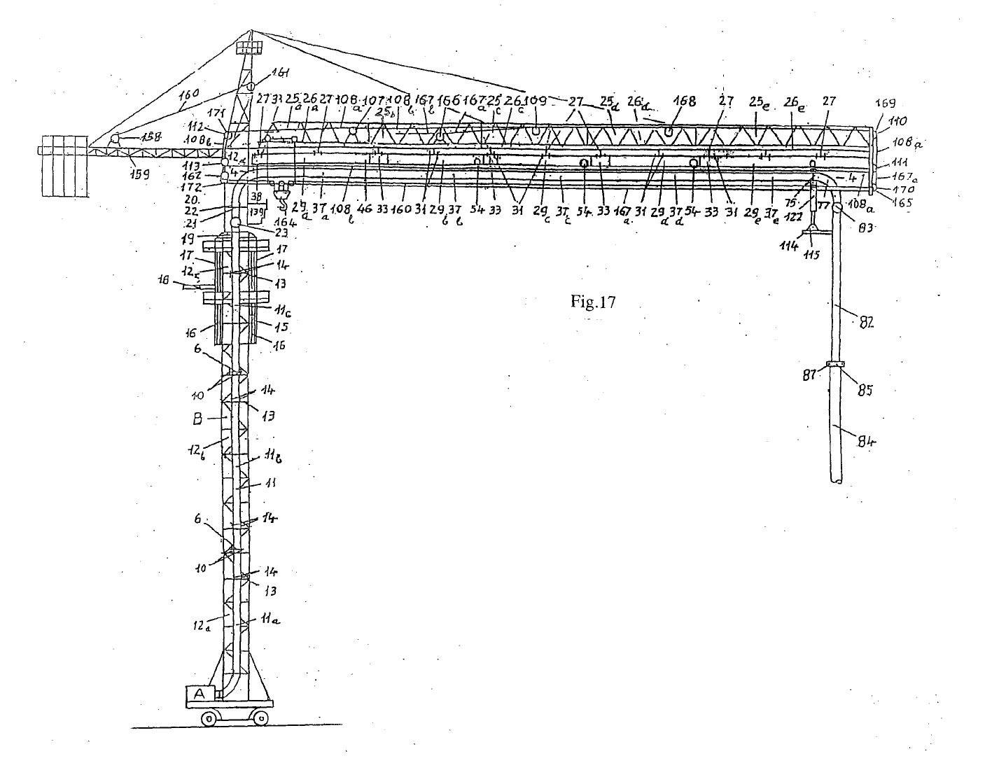

FIG. 15 shows the summary picture of cable tackle for heavy structure lifting in crane tower, including electrical hoist 158 to be placed on the counterweight supporting arm 159, cable terminals 160 are fitted stably into coming drum 158 and crowning the pulley 161, which is fitted at tower head 12d, crowing the pulley 162 at tower head 12d and crowing the pulley 153, which is fitted at U profile sections 146, crowning the pulley 163 at parts of suspension hook 164, crowning the pulley 149 at the middle of U profile 146, crowning the pulley 163 at parts of suspension hook, crowning the pulley 153, which is fitted at U sections 146 and the final cable terminal 160 is fitted stably into steel shaft 165 at head of suspension hook 25 in crane tower.

FIG. 16 shows the summary picture of small-vehicle handling structure of lifting structure for moving things in steel bar 26, which is fitted at both sides of suspension arm 25, including electrical hoist 166, to be placed inside suspension arm 25, the central part of cable 167 is rolled in some rounds in the middle of coming drum 166 for creating of 02 cable branches 167a, 167b, the head of cable branch 167a is crowned through pulley 168, which is fitted next to suspension arm 25 for supporting of cable branch 167a, so that, the cable branch cannot touch the lower side of suspension arm 25, then, this cable branch 167a is crowned through pulleys 169, 170 at heads of suspension arm 25 for changing of direction of cable 167a and heads of cable 167a are fixed stably into steel shaft 156 at heads of U profile 146 as shown above (FIG. 1), while the other head of cable branch 167b is crowned the pulleys 171, 172, which are fitted at head of tower section 12d for changing of direction of cable branch 167b and the final cable terminal 167b is fitted into steel shaft 156 at heads of U profile 146.

Although not to be described in this part, it is necessary to understand that, control systems of concrete spreader and crane tower complex mentioned in this document are connected to power control system, oil supply and hydraulic control system, ensuring for operation of concrete pump, electrical hoist and hydraulic piston cylinder, power and hydraulic control system are known and the detailed description of their structure, functions and operation can be discarded.

The complex of concrete spreader A and crane tower B as specified in the invention and as described above, is operated as follows:

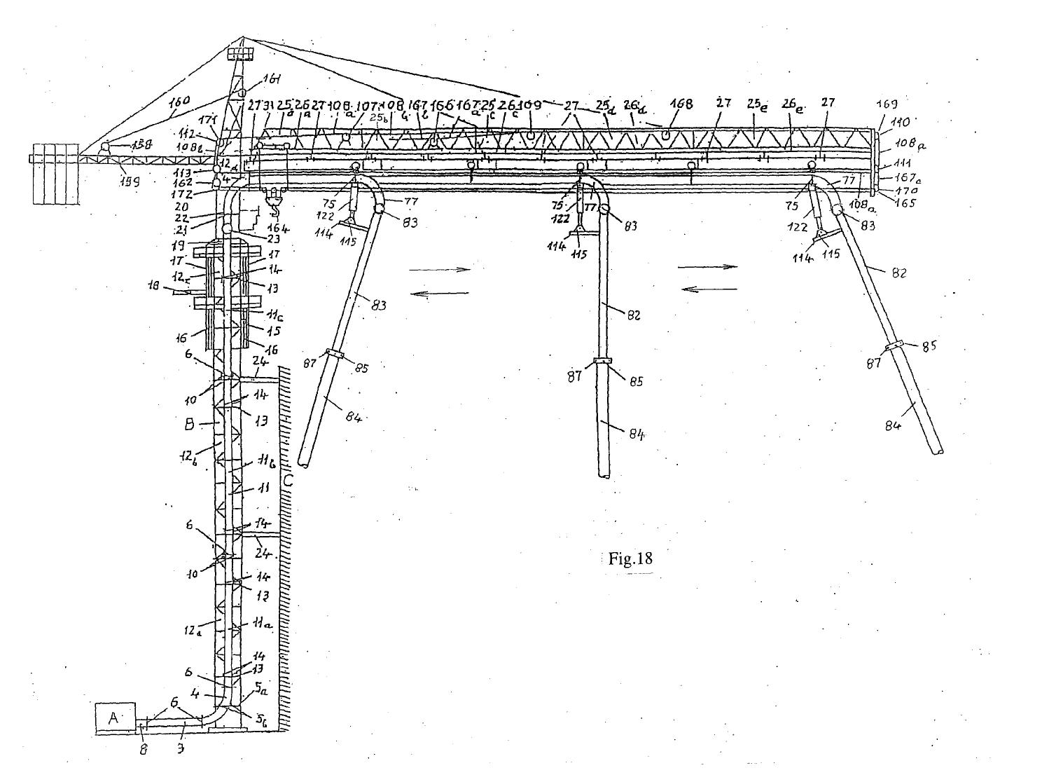

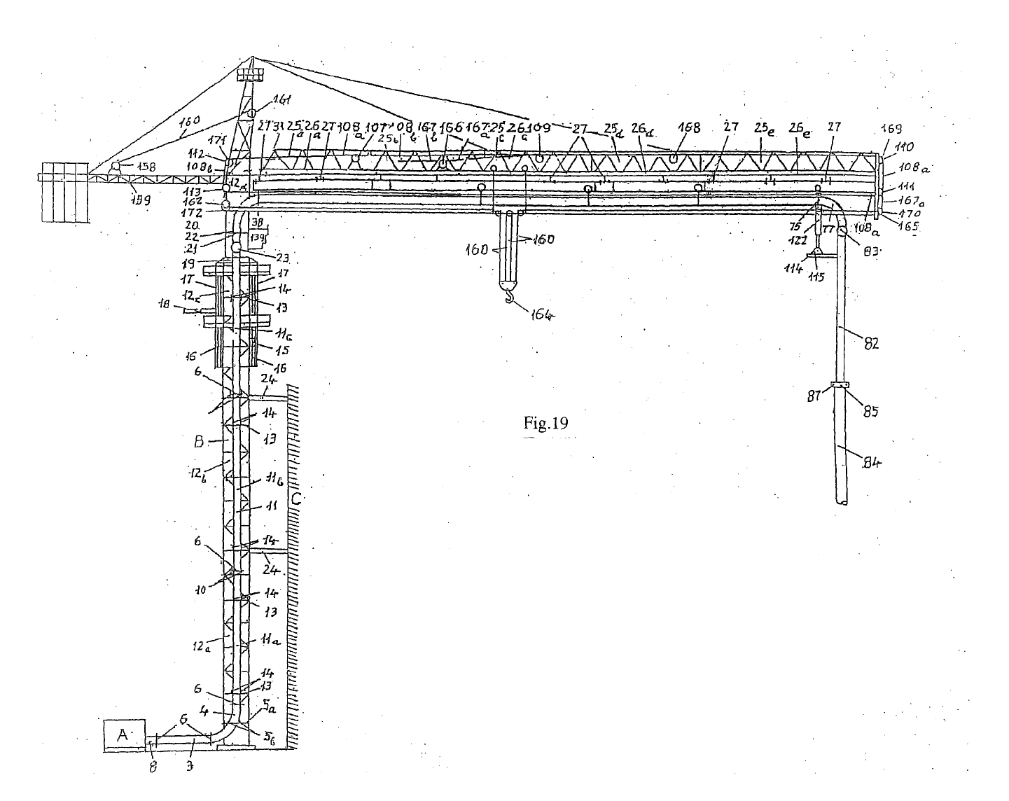

After parts and structure for constructing height of the floors, house are assembled by crane tower B, the crane tower is operated continuously for transporting of tremie pipe sections 37a, 37b, 37c, 37d and 37e and tremie pipes 72, 82, 84 under suspension arm 25 to the working position, braking structures 88 start to be operated in the order of drawing heads of braking latch 101 out of holes 106 at back head of sleeve 37c, 37d, 37c and 37b, as well as electrical hoist 107 placed inside suspension arm 25 also starts to release cable branch 108a and crowning cable branch 108b into the coming drum for pushing of tremie pipe section 37c to slip over section 37d, this section 37d is embedded into section 37c, the section 37c is embedded into section 37b and the section 37b is embedded into section 37a with length of section 37 to be the shortest (FIG. 18), also piston cylinder will pull steel section 114 up for pushing sections 82, 84 to be inclined backward at the shortest reach, at the same time, the concrete pump will start to pump concrete into tremie pipes 3, 4, 11, 20 and 37e for pipe sections 77, 82, 84 to grout on the floor, column under construction. Also, electrical hoist 107 continues to change over to release cable branch 108b, then crowning 108a into the coming drum for pulling pipe section 37e to be lengthened for pipe sections 82, 84 to grout in the floor to the full length of pipe section 37c, at the same time, brake latch 88 will push latch head 101 into hole 106 at the back head of pipe section 37e for braking it at fixable position and this brake latch head 101 will transfer tensile force into head of 37d for electrical hoist to continue to pull out pipe section 37d to concrete positions until the end of pipe section 37d, in order for latch structure 88 to push latch head 101 into hole 106 at the back head of pipe section 37d for braking it fixable position and this brake latch head 101 will transfer tensile force into head of 37c for electrical hoist 107 to continue to pull out pipe section 37c to concrete positions until the end of pipe section 37c, in order for latch head 101 into hole 106 at the back head of pipe section 37c for braking it fixable position and this brake latch head 101 will transfer tensile force into head of 37b for electrical hoist 107 to continue to pull out pipe section 37b to concrete positions until the end of pipe section 37b, in order for in order for latch structure 88 to push latch head 101 into hole 106 at the back head of pipe section 37b, in order for pipe section 37b to stop moving with length of pipe section 37 to be the longest (FIG. 18) and while sections 37e, 37d, 37c and 37b to be lengthened to concrete positions in the floor, piston cylinder 122 also pushes lever arm 114 down to put pipe sections 82, 84 into vertical positions for grouting floor, beam, column and pushing pipe sections 82, 84 to be inclined ahead for grouting at longest reach in range of construction plane, floor and pre-cast yard, at that time, the rotary structure 19 in crane tower turns suspension arm 25 and pipe sections 37a, 37b, 37c, 37d and 37e and tremie pipe sections 77, 82, 84 on horizontal plane for side displacement a pre-fixed distance, then, braking structure 88 will draw head of brake latch 101 out of hole 106 at back head of 37c, 37d, 37c and 37b, then electrical hoist 107 will change over to release cable branch 108a for crowning of 108b into coming drum 107 and pushing tremie pipe section 37e, 37d, 37c and 37b in the order for them to embed one another and embedding completely in pipe section 37a to be shortened from longest reach to the shortest one, for grouting in the floor, beam and column. The coordination at the same time of operation structures in crane tower B with concrete spreader A is carried out continuously, uniformly and accurately, then this process is repeated for grouting in the floor, beam and column as specified by process of concreting when constructing a house or an architectural work. And the next step of the solution for invention implementation is that, hydraulic oil pressure pump 15 is set at self-lifting structure in crane tower, making piston cylinder 16 to lift tower sections 12c, 12d and tremie pipe section 11c, suspension arm 25 and tremie pipes 37, 77, 82 and 84 to the specified height, in order for crane tower to lift tower section 12c tremie pipe section 11c to the height to tighten into lower and upper head of tower section 12c, tremie pipe section 11c, so that, crane tower and concrete spreader can stand working at new floor and grouting in the higher next floor.

### EFFECT OF THE INVENTION

Concrete spreader to be fitted on the crane tower can be applied for all types of other known crane tower with tremie pipe sections 3, 4, 11, 20, 37, 77, 82 and 84 to be placed horizontally, vertically, slantingly, as specified above, which is fitted in tower section 12, on suspension arm 25 and using these parts for self lifting of height of concrete spreader to the working height, self-lengthening of tremie pipe section to concrete position in construction plant of architectural works, pre-casted yards.

Due to that, concrete spreader A is fitted in crane tower B for forming a complex of complete concrete spreader and crane tower with capability of self-lifting for concrete spreader height to working height, self-lengthening of tremie pipe section to concrete position, self-moving of concrete spreader to working positions in range of construction area for house, architectural work and concrete yard, so that, working efficiency of concrete spreader and crane tower is not only increased, but their usage efficiency is also enhanced and construction time can be shortened.

As known from above description, if the height of crane tower B is larger, length of suspension arm of crane tower B is higher, then, height of concrete spreader and far reach of concrete spreader will also increased, meeting technical design requirements for construction of houses, pre-cast yards.

As mentioned above, the whole invention has been specified and described with its recommended solutions. However, this is also understood that, as for experts specialized in this technical aspect, it is easy for them to realize that, any change and/or other adjustment carried out but not to exceed the range of invention are specified with the following protective points:

1. The complex of concrete spreader and crane tower is included: concrete pump, concrete tank placed on the ground, tremie pipe section placed horizontally near the ground base, tremie pipe section fitted on steel sections placed horizontally inside the foot of crane tower, the front head of tremie pipe is fitted into the back head of curved pipe section, the back head of pipe is fitted into the front head of pipe section at head of concrete pump by pairs of flange, the tremie pipe section is included pipe sections, to be fitted vertically inside tower sections thanks to steel section, to be placed horizontally and separated from one another a pre-specified distance at 02 opposite sides in tower sections and on these steel sections, steel sections are placed horizontally at both sides of pipe section, for forming 4-edge cylindrical steel structure frame and steadily supporting of tremie pipe sections inside tower section and the upper head, lower head of pipe sections and the upper head of curved pipe section is embedded one another by pairs of flange, while the upper head of pipe section is fitted in the middle of rotation structure in tower section and on this tower section, steel sections are placed horizontally at both sides in pipe section for steadily keeping of pipe section on this tower section, while the lower head of curved pipe section is fitted into the upper head of pipe section by empty ball bearing for leading of concrete and let the pipe section be able to turn around the ball bearing;
suspension arm fitted in front of crane tower is included sections, at both sides of suspension arm with 02 empty steel bar, for making of guide way for small vehicle with heavy thing lifting structure moving on suspension arm, in the lower side of suspension arm, I profile sections are placed in parallel, to be separated from a pre-fixed distance, in the lower side of I profile, a rectangular I profile, including, is fitted and in the lower side of I profile sections, tremie pipe sections is placed horizontally with structure including pipe sections to be embedded one another, the back head of tremie pipe is fitted into the front head of curved pipe section by pair of flange, while the front head, back head of tremie pipe section are fitted into pair of flange and the front head of sleeve section is fitted into the back head of curved tremie pipe section by pair of flange and in the upper part of pairs of flange, pairs of wheel is fitted at lower side of I profile for use it to be a guide way of sleeve sections to move to concrete positions in construction plane of house, while the lower head of tremie pipe is fitted into the upper head of tremie pipe by ball bearing with self-rotation function for tremie pipes on vertical plane in order for grouting from the shortest reach to longest reach, the lower head of tremie pipe is fitted into the upper head of tremie pipe by steel hoop for steadily tightening of upper head in expansion hose on pipe section;
latch structure is used for transfer of tensile force for sleeves to be lengthened or transferring of thrust force for these sleeves to be embedded one another and shortened, as well as transferring of brake force for these sleeves to stop moving, including 02 pipe sections, which are empty circular cylinder, the front head of pipe is fitted steadily into the side edge of front head of sleeves, while the back head, front head of pipe sections are tightened one another by screw, inside these section, the latch hoop, latch disc, one-way electromagnet discs, braking latch, stepping disc and spring are assembled for creating thrust force of braking larch to be always fitted into holes in front and back head of sleeve sections for transferring of tensile force on to be lengthened or transferring of thrust force on sleeve sections to stop moving and when the current is applied on, electromagnet discs are attached one another for being more prominent than thrust force of spring, at the same time latch heads is pulled out of hole for sleeve section to be lengthened or shortened at concrete positions;
tensile structure of sleeve sections moves in I profile sections, including electrical hoist to be placed inside suspension arm, the central part of cable wire is crowned some rounds in the
electrical coming drum for creating of cable branches and head of cable branch is crowned through pulley for supporting of cable branch, so that, it does not touch the lower edge of suspension arm, then crowning through pulleys at head of suspension arm, for changing the moving direction of cable branch and this head of cable branch is hooked into hole at claw's position at upper part of pair of flange, while the head of cable branch is crowned through pulleys in tower section for changing the moving direction of cable branch and this head of cable branch is inserted into holes at upper part of pairs of flange and this head of cable branch is hooked into hole at claw's position at upper part of flange until when the electrical hoist is operated to roll cable branch into the coming drum, at the same time, releasing of cable branch out of the coming drum in order for the cable branch to pull sleeves to be lengthened, or when the electrical hoist is changed over, rolling the cable branch into the coming drum, releasing of cable branch out of the coming drum, at the same time, so that, the cable branch will pull sleeves to be embedded one another for being shortened at concrete positions;
slanting structure makes the tremie pipe inclined backward for the shortest concreting reach and inclined ahead for the longest concreting reach, including I profile section to be placed horizontally, separated from ball bearing a pre-fixed distance, the front head of I profile is tightened into the back edge of tremie pipe, the front head of steel section is fixed with 02 steel pieces in vertical way, in the middle of 02 these steel pieces, there is a hole for fitting of steel shaft, which will be described below. At both sides of pair of flange, 02 steel pieces are fixed vertically in front head of tremie pipe and in back head of tremie pipe, on these 02 steel pieces are fixed with 02 steel pieces, to be placed vertically and on these 02 steel pieces, hydraulic oil pump and oil tank are assembled, in lower part of flange, a steel claw is fixed vertically and in the middle of this claw, there is a round hole, the upper head of hydraulic piston cylinder has a round hole for fitting into hole in the steel claw by steel shaft for steadily keeping of piston cylinder below this flange, the lower head of piston cylinder has a round hole and steel shaft is used for fitting into holes at 02 steel pieces and hole for keeping the lower head under the piston cylinder on the steel section, in order when the hydraulic piston cylinder pulls the steel section on height, at the same time, tremie pipe sections are also pulled to be inclined backward at the shortest concreting reach, or the piston cylinder pushes the steel section down for pushing tremie sections ahead for concreting at longest reach.

2. The complex of concrete spreader and crane tower is as specified at claim 1. In which, pairs of flange 6 is fitted into the front and back head of tremie pipes and into the upper and lower head of tremie pipe for increase the stability of these pipe sections and making them tight, so that the concrete cannot seep out.

3. The complex of concrete spreader is according to claim 1. In which, the tremie pipe sections are placed vertically inside the tower sections, inside the self-lifting structure and inside the rotation structure of crane tower, in order to use these parts for steadily supporting of sections on the crane and lifting tremie pipes up to working height and turning pipe section around crane tower.

4. The complex of concrete spreader is according to claim 1. In which, the ball bearing is fixed into in upper head of pipe section with function of self-rotation for pipe section on horizontal plane for concreting around the complex and sealing of upper and lower head of pipe sections, so that, concrete cannot seep out.

5. The complex of concrete spreader is according to claim 1. In which, pairs of flanges are fixed into front head of I profile for supporting of pipe sections when they are embedded steadily and safely.

6. The complex of concrete spreader is according to claim 1. In which, pairs of flanges are fitted into the front and back head of sleeve sections to be fitted in lower edge of I profile for supporting of sleeve sections to be lengthened or shortened at concrete positions and sealing of these sleeve sections.

7. The complex of concrete spreader is according to claim 1. In which, the ball bearing is fitted in lower and upper head of tremie pipe, for steadily supporting of pipe sections in the ball bearing, in order when the piston cylinder to be fitted into pair of flange, which is fixed in the head of steel section, pulls both sections around the ball bearing at position of backward inclination, keeping these pipe sections at vertical position and pushing these pipe sections at ahead inclination position at concrete positions.

8. The complex of concrete spreader is according to claim 1. In which, the electrical hoist, to be fitted inside the suspension arm, is operated, in order for cable branch to lengthen tremie pipe sections and for cable branch to pull these sections to be embedded one another, so that they are shortened at concrete positions.
